(19) United States
(12) Patent Application Publication
(10) Pub. No.: US 2024/0368380 A1
(43) Pub. Date: Nov. 7, 2024

(54) MATTING AGENTS BASED ON PRECIPITATED SILICAS

(71) Applicant: Evonik Operations GmbH, Essen (DE)

(72) Inventors: Thomas Klotzbach, Seligenstadt (DE); Sascha Herrwerth, Freigericht (DE); Andreas Feller, Sulzbach (DE); Siegfried Heeg, Hoesbach (DE); Uwe Schmeier, Hasselroth (DE); Jan Hendrik Heinzinger, Hainburg (DE); Doris Mißelich, Weilerswist (DE)

(73) Assignee: Evonik Operations GmbH, Essen (DE)

(21) Appl. No.: 18/654,534

(22) Filed: May 3, 2024

(30) Foreign Application Priority Data
May 5, 2023 (EP) 23171810.7

(51) Int. Cl. C08K 9/04

(52) U.S. Cl. CPC C08K 9/04; C08K 2201/005; C08K 2201/006

(57) ABSTRACT

The invention relates to precipitated silica, characterized by
BET: 150 m²/g-400 m²/g, preferably 200 m²/g-300 m²/g, determined to ISO 9277
DOA: 220 ml/100 g-400 ml/100 g, preferably 250 ml/100 g-350 ml/100 g, determined to ISO 19246
d₅₀: 3.0 μm-5.0 μm, determined by laser diffraction on a Coulter LS to ISO 13320,
particle size ratio d₅:d₅₀:d₉₅: >0.3:1:<2,
particle size distribution d₉₅−d₅/d₅₀: between 1.3 and 1.7.

### CROSS-REFERENCE TO RELATED APPLICATIONS

This patent application is based on and claims priority pursuant to 35 U.S.C. § 119 to European Patent Application No. 23171810.7, filed on May 5, 2023. The content of this application is hereby incorporated by reference in its entirety.

### BACKGROUND

### Field of the Invention

The present invention relates to matting agents based on precipitated silicas, to the production thereof and to the use thereof in paints and coatings.

Coatings are applied to surfaces or substrates for decorative, functional or protective purposes. They decorate, protect and preserve materials such as wood, metal or plastic. The coatings may be highly glossy or matt.

### Description of Related Art

It used to be the case that coatings such as paints and printing inks were matted subsequently by controlled roughening of the surfaces in the microscale range. As a result, the light incident on the roughened surface is not reflected in a directed manner, but scattered diffusely. The more diffusely the light is scattered, the more matt the appearance of the surface to the human eye.

Nowadays, matting agents are used, which are incorporated into paint systems. Matting agents typically consist of precipitated or fumed silicas, silica gels, polymethylureas or waxes. They are subject to many demands. Accordingly, on the one hand, a good matting effect is required; on the other hand, they should not have an adverse effect on the tactile properties of the paint film surfaces and/or the transparency. In addition, they should have good dispersibility in paint production.

It should be possible to give the paint film surfaces a silky matt to dull matt appearance at various levels of matting, but without looking rough. Accordingly, the roughness of matt surfaces is also determined by the particle size and shape of the matting agent. In the case of coarse matting agents, paint film surfaces look matt but rough.

The matting agent is based on the effect of silica particles that project out of the surface, which form a microstructure as the paint system dries. The rays of light are scattered in all directions at the resultant peaks and valleys. A method that has become established for quantification of the degree of mattness/gloss is the measurement of the reflected light component at an angle of 60°.

Coarse particles are fundamentally more easily dispersible than finely divided particles, since a much higher surface area has to be wetted in the case of fine particles. Moreover, fine particles have a much stronger tendency to reagglomerate because of the high surface energy.

For avoidance or reduction of this tendency, which is particularly important in paint production, it would be desirable to provide matting agents where it is possible to reduce the amount thereof used as the gloss level stays the same without adversely affecting transparency, dispersibility and/or tactile properties.

### SUMMARY OF THE INVENTION

The present invention therefore provides precipitated silicas characterized by the following physicochemical parameters:

$$BET : 150 {m}^{2} / g - 400 {m}^{2} / g , \\ preferably 200 {m}^{2} / g - 300 {m}^{2} / g , measured to ISO 9277$$

$$DOA : 220 ml / 100 g - 400 ml / 100 g , \\ preferably 250 ml / 100 g - 350 ml / 100 g , determined to ISO 19246$$

$${d}_{50} : 3. μm - 5. μm , \\ determined by laser diffraction on a Coulter LS to ISO 13320 ,$$

$$particle size ratio {d}_{5} : {d}_{50} : {d}_{95} : > 0.3 : 1 \text{:<} 2 ,$$

$$particle size distribution \frac{{d}_{95} - {d}_{5}}{{d}_{50}} : between 1.3 and 1.7 .$$

A median particle size of the precipitated silica according to the invention can be determined to ISO 13320:2009 by laser diffraction particle size analysis. The resulting measured particle size distribution is used to define the median d₅₀, which reflects the particle size not exceeded by 50% of all particles, as the average particle size.

The specific surface area, also referred to simply as BET surface area, is determined to DIN 9277:2014 by nitrogen adsorption in accordance with the Brunauer-Emmett-Teller method.

The DOA absorption value is determined by means of a absorptometer equipped with a torque measurement and processing system. It can be used to assess the liquid absorption capacity of silicon dioxide, calcium silicate and sodium aluminosilicates. The daily absorption value gives a pointer to the carrier capacity of a filler.

Experience has shown that a great amount of precipitated silica with smaller particle sizes is required than in the case of precipitated silicas having larger particle sizes for achievement of the same gloss level.

It has been found that, unexpectedly, it was possible to reduce the amount of the precipitated silica according to the invention used by comparison with a commercial finely divided matting agent. For example, it was possible to reduce the amount used in various paint systems over a broad range of gloss levels, measured at an angle of 60°. Reference is made here to the examples.

The reduced use amount of the precipitated silica according to the invention also constitutes an important product property with regard to efficiency (economic viability). The more efficient a silica, the less has to be used in the corresponding paint system to achieve a defined gloss level.

In addition, it has been established that it was possible to increase the transparency of clearcoats. The density Dy (transparency) of the matted clearcoats was measured with an eXact densitometer from X-Rite, in accordance with DIN 55988. The matted clearcoats in the different paint systems were applied here to black PMMA sheets, with comparison of the various matting agents by adjustment of the gloss levels always to the same gloss level considered in the particular case, measured at 60°. Transparency is then ascertained by the diffuse reflection at an angle of 45° via a logarithmic calculation. The parameters for the measurement were set as follows:

| Parameter | Settings |
|---|---|
| Measuring conditions | M0 (no): no filter |
| Density Status | ISO Status E |
| Density White Base | Absolute |
| All Densities | CMYK |
| Density/Tone Value | Solid: CMYK |
| Density/Tone Value | Tint: Tone Value |
| Tone Value/Spot | SCTV (ISO20654) |
| Illuminant/Observer | D65/2°/10° |

It should be noted here that the transparencies of the matted clearcoat systems can be compared with one another only when the gloss level is the same. Comparison with equal dosage of the silica is impermissible. The measured transparency value Dy is a logarithmic numerical value. Thus, the higher the Dy value, the more transparent the matted clearcoat.

### BRIEF DESCRIPTION OF THE DRAWINGS

FIG. 1 shows an SEM image of a clearcoat coating in cross section, incorporating the silica particles.

FIG. 2 shows a grindometer image of K1 and K2.

FIG. 3 shows a grindometer image of VG1 and VG2.

FIG. 4 shows a graph of a determination of pore volume by means of the Hg porosimeter.

### DETAILED DESCRIPTION OF THE INVENTION

The median pore diameter of the precipitated silica according to the invention is preferably less than 7.0 μm, preferably less than 5.0 μm and more preferably less than 3.0 μm, measured with an Autopore IV 9520 to ISO 15901-1, with the following instrument settings: contact angle of 140° and pressure range of 0.003-420 MPa, and determined in the pore diameter range of 3.5 nm-500 μm, determined after the grinding of the silica.

The silica according to the invention preferably has a unique morphology, especially the porosity thereof, which can be illustrated by mercury porosimetry.

The precipitated silica according to the invention preferably has a pore volume of 2.20 ml/g Hg (d=0.1 μm−d=3.0 μm)−2.90 ml/g Hg (d=0.1 μm−d=3.0 μm), determined by means of the Hg porosimeter.

The precipitated silica according to the invention preferably has a pore volume of 2.40 ml/g Hg (d=0.1 μm−d=4.0 μm)−3.10 ml/g Hg (d=0.1 μm−d=4.0 μm), determined by means of the Hg porosimeter.

The precipitated silica according to the invention preferably has a pore volume of 2.50 ml/g Hg (d=0.1 μm−d=5.0 μm)−3.30 ml/g Hg (d=0.1 μm−d=5.0 μm), determined by means of the Hg porosimeter.

The determination of the Hg pore diameter (d<4 μm or d<5 μm) is based on mercury intrusion according to DIN 66133, and an AutoPore V 9600 instrument from Micromeritics is used. The process principle is based on the measurement of the volume of mercury injected into a porous solid as a function of the pressure applied.

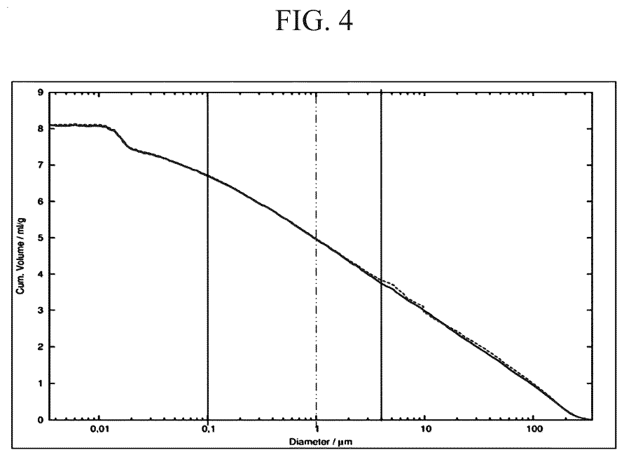

FIG. 4 shows a graph of a determination of pore volume by means of the Hg porosimeter. It illustrates, for example, the unique morphology of the inventive silica K2. The vertical lines at d=0.1 μm and d=4.0 μm represent a region nominated for the invention. The difference in the accumulated pore volumes (ml/g) represents the pore volume for this region (see Table C). For the calculation, the points of intersection of the respective vertical lines with the graph are each read off and calculated.

It can additionally be inferred from the graph that, in a region up to a pore diameter of d<1 μm, the cumulated pore volume is 4.9 ml/g. For this purpose, a vertical dotted line is set at d=1 μm. The value at the point of intersection with the graph can be read off. In the case of a pore volume of less than 4.9 ml/g, the graph would have a flatter progression, and as a result the silica particles would have a smaller pore volume.

The silicas according to the invention have a very much smaller average pore diameter than comparable commercial silicas that are used as matting agents. In spite of the much smaller pore diameter, it has been found that they can absorb more mercury. The higher number of smaller pores on average brings a crucial advantage in terms of transparency, especially in the case of waterborne paint systems.

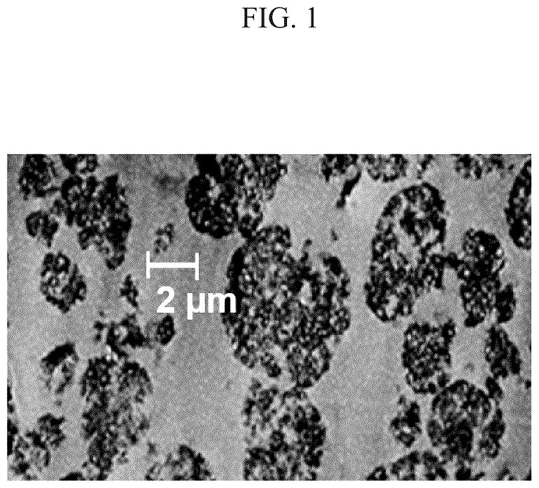

FIG. 1 shows an SEM image of a clearcoat coating in cross section, incorporating the silica particles. Because of the morphology or porosity of the silicas, they behave like a sponge and are filled throughout with the transparent binder. Since the binder and silica have a similar refractive index, the matted clearcoat still remains largely transparent after drying.

Aqueous binders are dispersions of polymer particles in an aqueous phase. The diameter of the spherical polymer particles may be between a few tens of nanometres and a few micrometres. As the paint film dries, water and any cosolvents evaporate, which reduces the volume, and the dispersion begins to coagulate. The dispersion particles come ever closer to one another and ultimately begin to fuse, which can be referred to as coalescence. At the end of the coalescence, a homogeneous binder film is formed, in which the particle boundaries of the binder have disappeared. The binder particles can penetrate efficiently into the many pores and form films in the pores. The more pores are present, the greater the blurring of the differences in refractive index between silica and binder, which leads to improved transparency, which has been found in the case of the silicas according to the invention in the corresponding binder systems.

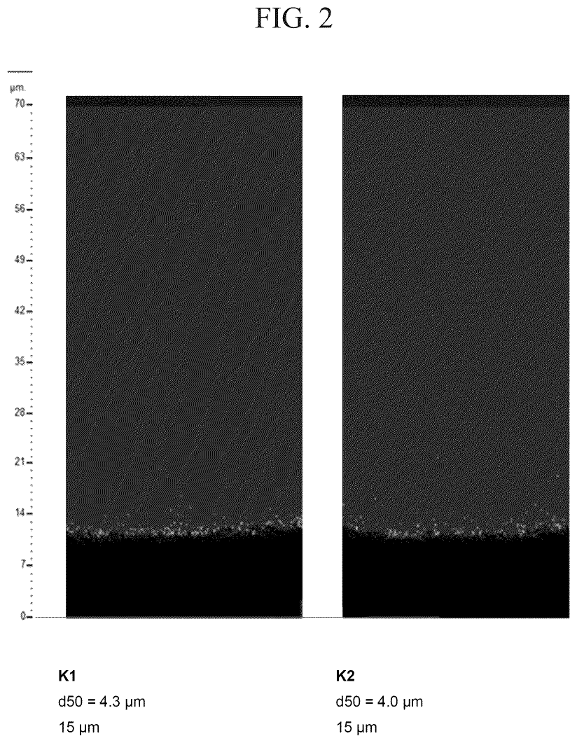

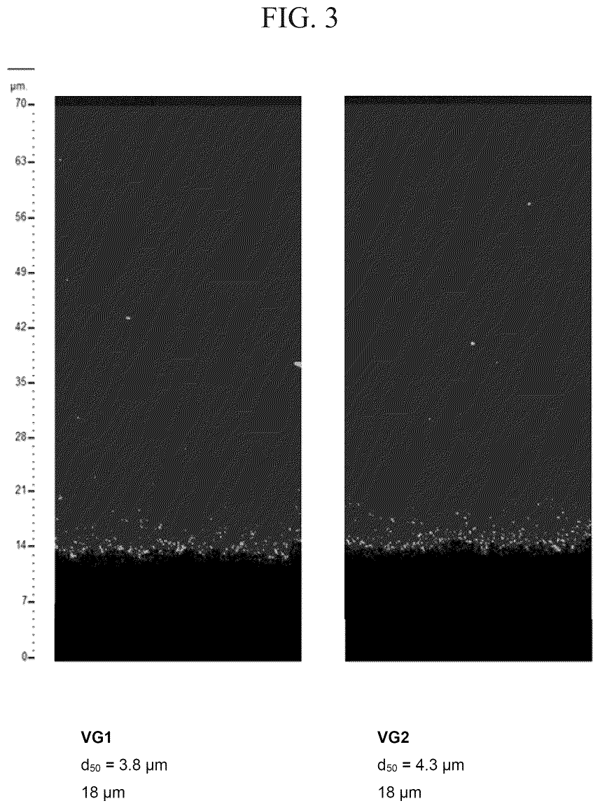

The dispersibility of the precipitated silica according to the invention in various paint systems has also been surprisingly improved. A grindometer can be used to indirectly determine dispersibility. Determination by grindometer is in accordance with DIN EN ISO 1524. It can be correlated with speck formation in the dry paint films, such that the unwanted specks or oversize can be recognized with the aid of the grindometer. Moreover, it is also possible via this method to recognize the tendency of a precipitated silica to reagglomerate, which often increases with decreasing particle size distribution. Reference is made here to FIGS. 2 and 3.

In the case of many precipitated silicas with d50 values of less than 5 μm, the silica particles have a tendency to reagglomerate during storage, which can be recognized by an increasing number of specks in the grindometer image over time. Usually, the tendency of untreated silicas to be reagglomerated higher than in the case of those having organic coverage of the surface. This may already be the case after a few days in the case of silicas having a high tendency to reagglomerate, or only after weeks or months in the case of higher stability. In the case of the silicas according to the invention, by contrast, this was not observed, and hence confirms the very low tendency to speck formation. Without being tied to any theory, it is assumed that the specific morphology and pore distribution of the silica according to the invention not only have an advantageous effect on dispersibility, but also result in high stability to reagglomeration.

Tamped densities of various pulverulent or coarse-grain granular materials can be determined according to DIN ISO 787-11:1995 “General methods of test for pigments and extenders—Part 11: Determination of tamped volume and apparent density after tamping”. This involves measuring the bulk density of a bulk material after agitation and tamping.

For uniform matting action, the aim is a very narrow particle size distribution. Particle size distribution can be determined in a simple manner, for example by measurements of the d5, d50 and d95 values. Untreated or wax-coated precipitated silicas in accordance with the invention therefore have a particle size distribution (span), defined by the quotient (d95−d5):d50, between 1.3 and 1.7.

A further property is also the particle size ratio of d₅:d₅₀:d₉₅.

The precipitated silica according to the invention preferably has a d₅₀ of 3.5-4.5 μm.

As well as the untreated hydrophilic silicas, the use of wax-coated silicas as matting agents is also known. Such a wax treatment distinctly improves the sedimentation characteristics of the precipitated silicas.

The present invention therefore further provides wax-coated precipitated silicas, characterized by

$$BET : 150 {m}^{2} / g - 400 {m}^{2} / g , \\ preferably 200 {m}^{2} / g - 300 {m}^{2} / g , determined to ISO 9277$$

$$DOA : 220 ml / 100 g - 400 ml / 100 g , \\ preferably 250 ml / 100 g - 350 ml / 100 g , determined to ISO 19246$$

$${d}_{50} : 3. μm - 5. μm , \\ determined by laser diffraction ( Coulter LS ) to ISO 13320 ,$$

$$particle size ratio {d}_{5} : {d}_{50} : {d}_{95} : > 0.3 : 1 \text{:<} 2 ,$$

$$particle size distribution \frac{{d}_{95} - {d}_{5}}{{d}_{50}} : between 1.3 and 1.7 .$$

$$carbon content : 1. - 6. \% by weight , preferably 2.4 - 3.8 \% by weight , \\ determined by LECO to ISO 3262 - 19.$$

The procedure for production of the precipitated silicas according to the invention was, for example, as follows.

A precipitation vessel was initially charged with 13.5 m³ of water at a temperature of 50° C. with continuous stirring, to which commercial waterglass was added at a rate of 14.85 m³/h, and the addition was ended after 10-15 min. Subsequently, the mixture is heated to a temperature of 70° C. Then 96% sulfuric acid is added at 0.27 m³/h within 25-35 min and sheared and stirred constantly, keeping the temperature at 85° C. by closed-loop control. After a period of time between 1.5 h-3.5 h, the suspension is acidified with sulfuric acid within 50-80 min until the pH is within the range of 3.5 to 3.9.

The solids can be separated from the suspension by known filter operations, for example a filter press (membrane filter press). The filtercake washed with demineralized water should then be subjected to drying. For this purpose, many kinds of drying methods are known to the person skilled in the art (Ullmann's Encyclopedia of industrial chemistry, 1992, 5th Edition, vol. 1, pages 7-25). Advantageous drying operations have been found to be those by means of flow dryers, spray dryers, staged dryers, belt dryers, rotary tube dryers, spin-flash dryers or nozzle towers. The drying is more preferably effected by spray dryer or staged dryer.

For the drying by spray dryer, the filtercake is liquefied with water under the action of shear forces and adjusted to a solids content of <15%, preferably 7.0-14.0%, more preferably 9-12%.

The precipitated silica obtained after drying can either be subjected to direct classifying grinding, or it is also possible to simultaneously coat the silica according to the invention with wax during the classifying grinding, in which case coating with 2-15% by weight, preferably with 5-10% by weight and more preferably with 3-6% by weight has been found to be useful.

As well as the wax impregnation of silicas mentioned, other methods are also known for this purpose and can be read about, for example, in DE 1006 100, DE1592 865 or EP 0922 691.

Wax suspensions are reacted here with the silica suspension, optionally mediated by a disperser.

In order to obtain the desired narrow particle distribution of the precipitated silica and the desired d₅₀ of 3.0-5.0 μm, a classifying grinding operation was conducted with a conventional air jet mill, e.g. Netzsch CGS 50.

The untreated or wax-coated precipitated silicas according to the invention may be used as matting agents in paints or coatings. In particular, they can be used for production of dispersions, millbases, paints, coatings or printing inks, inkjet inks, grind resins, pigment concentrates, colour preparations, pigment preparations, filler preparations or coating compositions.

The examples that follow are intended to further elucidate the invention, but not to restrict the scope of protection as set out in the description herein:

### Methods

Tamped density [g/l] was determined to DIN ISO 787-11:1995.

Specific BET surface area [m²/g] was determined to DIN 9277:2014 by nitrogen adsorption by the Brunauer-Emmett-Teller method.

The DOA absorption value is determined in accordance with ISO 19246 by means of an absorptometer, from Brabender, equipped with a torque measurement and processing system. It can be used to assess the liquid absorption capacity of silicon dioxide, calcium silicate and sodium aluminosilicates. The daily absorption value gives a pointer to the carrier capacity of a filler.

The density Dy (transparency) of the matted clearcoats was measured with an eXact densitometer from X-Rite, in accordance with DIN 55988. The matted clearcoats in the different paint systems were applied here to black PMMA sheets, with comparison of the various matting agents by adjustment of the adjustment of the gloss levels always to the same gloss level considered in the particular case, measured at 60°. Transparency is then ascertained by a diffuse reflection at an angle of 45° via a logarithmic calculation. The parameters for the measurement were set as follows:

| Parameter | Settings |
|---|---|
| Measuring conditions | M0 (no): no filter |
| Density Status | ISO Status E |
| Density White Base | Absolute |
| All Densities | CMYK |
| Density/Tone Value | Solid: CMYK |
| Density/Tone Value | Tint: Tone Value |
| Tone Value/Spot | SCTV (ISO20654) |
| Illuminant/Observer | D65/2°/10° |

Determination by grindometer is in accordance with DIN EN ISO 1524.

A black melamine baking lacquer and a TIDAS instrument for automatic grindometer drawdowns for the determination of dispersion fineness from Labman were used to assess the dispersion characteristics of the various matting agents.

In order to create the grindometer images shown in FIGS. 2 and 3, the black medium-solids baking lacquer from AXALTA Coating Systems Austria GmbH, named DUPLEX D 1326, formulation number B11830875, was used with the appropriate V 0003 thinner (from Axalta). The appropriate amount of the precipitated silica which is required to adjust the gloss level of the dry paint layer to 20 GU, measured at a 60° angle, is stirred here into 100 g of paint with a paddle stirrer at 2000 rpm for 10 minutes. The paint is then applied in liquid form to the grindometer block with a maximum channel depth of 70 μm and automatically applied by knife-coating and evaluated with the TIDAS instrument.

Carbon content [% by weight] was determined to EN ISO3262-20:2000 (Chapter 8) by elemental analysis with the C632 carbon determination system (manufacturer: LECO). The sample analysed was weighed into a ceramic crucible, admixed with combustion additives and heated under an oxygen stream in an induction oven. The carbon present is oxidized to CO2. The amount of CO2 gas is quantified by infrared detectors (IR). SiC, if present, is not combusted and therefore does not affect the carbon content value.

Determination of Hg pore volume (d<4 μm, d<5 μm) is based on mercury intrusion according to DIN 15901-1, using an AutoPore V 9520 instrument from Micromeritics with the following device settings: contact angle of 140° and pressure range of 0.003-420 MPa, and in the pore diameter range of 3.5 nm-500 μm, after the grinding of the silica.

### EXAMPLES

### 1. Production of the Inventive Precipitated Silicas K1 and K2

A 20 m³ precipitation vessel was initially charged with 13.5 m³ of water at a temperature of 50° C. with continuous stirring, to which commercial waterglass (27.1% SiO2; 8.07% Na₂O; density 1.335) was added at a rate of 14.85 m³/h, and the addition was ended after 13 min. Subsequently, the mixture was heated to a temperature of 70° C. Then 96% sulfuric acid was added at 0.27 m³/h within 30 min and sheared and stirred constantly, keeping the temperature at 85° C. by closed-loop control. After a period of time of 120 min, the suspension was acidified again with sulfuric acid within 60 min, until the pH reached a value in the range of 3.5 to 3.9. The solids were separated from the suspension using a membrane filter press, and the filtercake was washed with demineralized water and then dried with a spray dryer. For the drying by spray dryer, the filtercake was liquefied with water under the action of shear forces and adjusted to a solids content of 10%.

The dried precipitated silica according to the invention was classified and ground with the aid of a Netzsch CGS 50 air-jet mill in accordance with the desired grain distribution.

K1 is an untreated silica according to the invention having the physicochemical properties according to Tables A-C.

K2 was produced analogously, with surface coverage of K2 with a commercial PE wax during the classifying and grinding in the mill, with adjustment of the amount of wax to a carbon content of 3.4%, measured with a LECO elemental analyser. The physicochemical indices of K2 are likewise apparent from Tables A-C.

The comparative examples cited were the commercial precipitated silicas from Tosoh.

TABLE A

| | | | BET | DOA absorption, | Particle size | Particle size | Particle size |
|---|---|---|---|---|---|---|---|
| Silica | Manufacturer | Surface | [m²/g] | [ml/100 g] | d5% | d50% | d95% |
| K1 | inventive | untreated | 266 | 324 | 1.8 | 4.3 | 7.6 |
| K2 | inventive | treated | 207 | 312 | 1.8 | 4.0 | 7.9 |
| VG1 | Tosoh | untreated | 146 | 250 | 1.1 | 3.8 | 8.2 |
| VG2 | Tosoh | treated | 135 | 248 | 1.3 | 4.3 | 9.0 |

TABLE B

| | Carbon | Tamped | Bulk | Drying loss 2 |
|---|---|---|---|---|
| Silica | content [%] | density [g/l] | density [g/l] | h/105° C. [%] |
| K1 | — | 78 | 67 | 4.6 |
| K2 | 3.4 | 70 | 62 | 5.1 |
| VG1 | <0.05 | 76 | 64 | 4.9 |
| VG2 | 0.32 | 80 | 68 | 4.3 |

TABLE C

| | Average pore diameter | Cum. volume [ml/g] | Cum. volume [ml/g] | Cum. volume [ml/g] |
|---|---|---|---|---|
| Silica | (volume) [μm] | 0.1 μm-3.0 μm range | 0.1 μm-4.0 μm range | 0.1 μm-5.0 μm range |
| K1 | 2.7998 | 2.90 | 3.10 | 3.30 |
| K2 | 2.8353 | 2.70 | 2.90 | 3.00 |
| VG1 | 8.0332 | 2.20 | 2.35 | 2.55 |
| VG2 | 8.8739 | 2.20 | 2.40 | 2.50 |

Tables A-C show the physicochemical indices of the precipitated silicas according to the invention, and comparative silicas VG1 and VG2. K1 is an untreated precipitated silica according to the invention. K2 is a wax-treated precipitated silica according to the invention. Comparative examples VG1 and VG2 are Tosoh precipitated silicas with the trade names Nipsil E-1011 (with organic aftertreatment according to the datasheet) (VG2) and Nipsil E-220A (VG1). The average particle size of these commercially available precipitated silicas has a similar d₅₀ to K1 and K2. It is known that VG1 and VG2 are used as matting additives.

The inventive precipitated silicas K1 and K2 showed a much higher DOA value compared to VG1 and VG2 from Tosoh with comparable particle size distribution (see Table A).

It was possible to illustrate the specific porosity of the inventive silicas K1 and K2 by mercury porosimetry. The corresponding values are shown in Table C.

The inventive silicas K1 and K2 showed a very much smaller average pore diameter at approx. 2.8 μm than precipitated Nipsil E 1011 (VG2) at 8.9 and Nipsil E-220A (VG1) at 8.0 μm. Nevertheless, K1 and K2 were able to absorb more mercury within a pore range of 0.1-3.0 μm, 0.1-4.0 μm and also 0.1-5.0 μm. The higher number of smaller pores on average brings a crucial advantage in terms of transparency, particularly in the case of waterborne paint systems.

### 2. Production of Paint Systems

Various paint systems were produced for the paint tests.

### 2.1 Paint System 1: 2K PUR Paint (DD Paint)

The solvent-based 2K PUR paint was produced according to the details from Table 1.

TABLE 1
Paint system 1

| | | | Pts. by |
|---|---|---|---|
| Item | Paint raw materials | Manufacturer | wt. (g) |
| 1 | Butyl acetate 98% | STAUB & CO.- | 11.0 |
| | | SILBERMANN GmbH | |
| 2 | Ethoxypropyl acetate | Möller Chemie Gmbh | 16.5 |
| | | & Co. KG | |
| 3 | Desmophen 800 | Covestro AG | 15.0 |
| 4 | Desmophen 1100 | Covestro AG | 20.0 |
| 5 | CAB 381-0.5, 10% in butyl | Krahn Chemie GmbH | 3.0 |
| | acetate 98% | | |
| 6 | Mowilit, 50% in ethyl | Celanese Emulsion | 0.3 |
| | acetate | GmbH | |
| 7 | Baysilone paint additive | OMG Borchers GmbH | 0.1 |
| 8 | Xylene | Merck | 34.1 |
| | | Total | 100.0 |

The individual paint raw materials were weighed out stepwise in the above sequence and homogenized with a laboratory dissolver. Homogenization was necessary after each of positions 4, 5, 6 and 7. There was a final homogenization of the paint after position 8.

### 2.2 Paint System 2: 1 K PU Acrylate, Wb (Clearcoat)

The water-based 1 K PU acrylate paint was produced according to the details from Table 2.

TABLE 2
Paint system 2

| Item | Paint raw materials | Manufacturer | Pts. by wt. |
|---|---|---|---|
| 1 | Dispersion Urethane 2012 | Michelman | 85.0 |
| 2 | Butylglycol | Evonik | 6.0 |
| 3 | Water | — | 6.0 |
| 4 | Tego Foamex 805 | Evonik | 0.2 |
| 5 | BYK 346 | BYK | 0.3 |
| 6 | Tego Viscoplus 3010 | Evonik | 0.5 |
| 7 | Water | — | 2.0 |
| | | Total | 100 |

Adjustment of the pH with AMP 95 (2-amino-2-methyl-1-propanol, 95% in water, from Carl Roth GmbH + Co. KG)

A preliminary mixture 1 was produced from positions 2 and 3 with an adjustment of pH by addition of AMP 95 to 8.5-9.0. A preliminary mixture 2 was likewise produced from positions 6 and 7. Then position 1 was initially charged, and preliminary mixture 1 was added while stirring. After successive addition of positions 4 and 5, preliminary mixture 2 was added. Finally, the clearcoat was homogenized at 1500 rpm for 10 min and introduced into an airtight canister.

### 2.3 Paint System 3: 1K Acrylate, Wb (Clearcoat)

The water-based 1 K acrylate paint was produced according to the details from Table 3.

TABLE 3
Paint system 3

| | | Raw material | |
|---|---|---|---|
| Item | Paint raw materials | manufacturer | Pts. by wt. |
| 1 | Alberdingk AC 3630 | Alberdingk | 80.0 |
| 2 | Tego Foamex 805 | Evonik | 0.2 |
| 3 | Tego Wet 270 | Evonik | 0.3 |
| 4 | Water | — | 13.0 |
| 5 | Butylglycol | Evonik | 6.5 |
| | | Total | 100 |

Adjustment of the pH with AMP 95 (2-amino-2-methyl-1-propanol, 95% in water, from Carl Roth GmbH + Co. KG)

A preliminary mixture was produced from positions 4 and 5 with an adjustment of pH by addition of AMP 95 to 8.5-9.0. Position 1 was initially charged, and the preliminary mixture was added while stirring. After successive addition of positions 2 and 3, the clearcoat was homogenized at 1500 rpm for 10 min and introduced into an airtight canister.

### 3 Application of the Paint Systems and Evaluation of the Surface Properties

### 3.1 Incorporation of the Silica in the Paint Systems

### Paint System 1:

In accordance with the weights from Table 3.1, the silica was introduced into 100 parts by weight of the paint system 1 in a 350 ml PE cup. It was ensured here that the silica was properly incorporated and did not stick to the edge of the cup. Subsequently, the then matted paint system 1 was dispersed with a 4.2 cm paddle stirrer at 2000 rpm for 10 min.

### Paint System 2:

95 parts by weight of paint system 2 and 5 parts by weight of Dowanol DPM (dipropylene glycol methyl ether, Dow Chemical) were mixed with stirring and stirred with a paddle stirrer at 1000 rpm for 5 min.

The appropriate weights of the silica according to Table 3.2 were incorporated in this mixture, except that the mixture was already being stirred continuously with the paddle stirrer on addition of the silica.

### Paint System 3:

The silica was incorporated in accordance with the weights according to Table 3.3 in an analogous manner to paint system 2.

VG1 and VG2 were incorporated analogously in the respective paint systems and weights from Tables 3.1-3.3.

### 3.2 Application of the Matted Paint Systems and Evaluation of the Surface Properties

After a deaeration phase of 30 min, the respective matted paint systems were drawn down onto black PMMA sheets with a Coatmaster 509 MC film applicator. For this purpose, a box-type coating bar with a gap height of 200 μm was used. The drawdown rate was set to 25 mm/s. The coated PMMA sheets were dried under climate-controlled conditions at 21-25° C. and a relative humidity of 40-60% overnight. The gloss level at 60° and the transparency of the dried matted surfaces was measured one day after application.

TABLE 3.1
Paint performance results for paint system 1

| Gloss at | Weight of matting agent [g/100 g] | | | | Transparency [Dy] | | | |
|---|---|---|---|---|---|---|---|---|
| 60° | K1 | K2 | VG1 | VG2 | K1 | K2 | VG1 | VG2 |
| 2 | 9.38 | 10.00 | 11.80 | 11.08 | 1.33 | 1.32 | 1.30 | 1.31 |
| 5 | 8.89 | 9.50 | 10.95 | 10.31 | 1.52 | 1.52 | 1.50 | 1.48 |
| 10 | 8.52 | 9.00 | 10.38 | 9.82 | 1.79 | 1.80 | 1.74 | 1.74 |
| 20 | 8.00 | 7.97 | 9.79 | 9.25 | 2.17 | 2.13 | 1.99 | 2.06 |

TABLE 3.2
Paint performance results for paint system 2

| Gloss at | Weight of matting agent [g/100 g] | | | | Transparency [Dy] | | | |
|---|---|---|---|---|---|---|---|---|
| 60° | K1 | K2 | VG1 | VG2 | K1 | K2 | VG1 | VG2 |
| 2 | 5.10 | 5.70 | 9.15 | 6.70 | 1.38 | 1.37 | 1.35 | 1.39 |
| 5 | 3.30 | 3.70 | 6.15 | 4.55 | 1.60 | 1.59 | 1.52 | 1.55 |
| 10 | 2.12 | 2.41 | 4.28 | 3.38 | 1.80 | 1.80 | 1.62 | 1.71 |
| 20 | 1.10 | 1.20 | 2.69 | 2.24 | 2.10 | 2.08 | 1.91 | 1.94 |

TABLE 3.3
Paint performance results for paint system 3

| Gloss at | Weight of matting agent [g/100 g] | | | | Transparency [Dy] | | | |
|---|---|---|---|---|---|---|---|---|
| 60° | K1 | K2 | VG1 | VG2 | K1 | K2 | VG1 | VG2 |
| 2 | 8.70 | 8.50 | 10.75 | 8.80 | 1.39 | 1.41 | 1.44 | 1.44 |
| 5 | 5.10 | 5.18 | 7.85 | 6.56 | 1.63 | 1.64 | 1.58 | 1.59 |
| 10 | 3.56 | 3.61 | 6.10 | 5.09 | 1.92 | 1.89 | 1.84 | 1.82 |
| 20 | 2.36 | 2.47 | 4.37 | 3.60 | 2.19 | 2.21 | 2.10 | 2.12 |

The three paint systems shown are representative of a multitude of standard binder systems where high-quality matted surfaces are desired. Aspects such as transparency and tactile properties in particular play an important role here in the matted coatings.

The inventive silicas K1 and K2, by comparison with the conventional precipitated silicas, showed higher efficiency (economic viability) in all three paint systems over the entire gloss range of 20 gloss points, measured at a 60° angle, down to the deep matt for 2 gloss values at the 60° angle. This means that, for attainment of the gloss levels shown in Tables 3.1-3.3, less silica had to be used than in the case of the conventional comparative silicas VG1 and VG2. Comparison of the efficiency makes sense only when the mutually compared silicas have a similar particle size distribution [see Table A (d5, d50 and d95)].

The inventive silicas K1 and K2 showed higher transparency values Dy compared to conventional silicas in the solvent-based paint system 1 over the gloss range from 20 to 2 gloss points at the 60° angle (Table 3.1). In the two aqueous paint systems 2 and 3 (Tables 3.2 and 3.3) as well, transparency values in the gloss range of 20 to 5 gloss units (60° angle) are higher across the board. It should be noted here that the transparencies of the matted clearcoat systems 1, 2 and 3 can be compared only when the gloss level is the same. Comparison with equal dosage of the matting agent is impermissible. The measured transparency value Dy is a logarithmic numerical value. Thus, the higher the Dy value, the more transparent the matted clearcoat.

For example, the precipitated untreated silica K1 in the 1 K acrylate paint system (paint system 3) has a Dy value of 2.19 at 20 gloss units (60° angle), whereas the untreated precipitate competitor silica Nipsil E-220A (VG1) has only a transparency value of 2.10. Thus, K1 has about a 23% higher transparency. The trained eye can visually perceive even differences in values of 0.03 ascertained by measurement.

Thus, this specific porosity of the inventive silicas K1 and K2 has a positive effect on efficiency and transparency in different coating systems.

### 4. Dispersion Characteristics According to the Grindometer Determination

100 g of DUPLEX D 1326 paint was weighed into a 350 ml polyethylene cup and 20 g of V 0003 thinner was weighed in. Then the amount of silicas specified in Table 4 was weighed in and incorporated cautiously into the thinned test paint with a spatula. Thereafter, the mixture was dispersed at 2000 rpm with a paddle stirrer, Ø 43 mm, for 10 min, while covering the PE cup to avoid evaporation losses. After the silica has been incorporated, the matted paint was left to stand in the closed beaker for deaeration for 30 min.

In order to assure comparability of the different silicas, Duplex D 1326 black paint was adjusted in each case with the matting agents listed in Tab. 4 to a gloss level of 20 gloss units (±0.1), measured at the 60° angle.

The adjustment of the gloss level was examined as follows:

On completion of deaeration, the paint was applied with a motorized drawdown device (Erichsen Coatmaster 509 MC) to cleaned glass panes (130×90×3 mm) at a speed of 25 mm/s using a square coating bar with gap height 120 μm. The square coating bar is weighed down with a block of VA steel (dimensions: 71×30×24 mm, weight: about 420 g) to increase the applied load. Each dispersed sample is to coat 2 glass panes. The paint applied is flashed off using the fixed flash-off conditions:
Temperature: 20° C. to 25° C.
Relative humidity: 40% to 60%
Flash-off time: 10 min to 20 min

The paint was then baked in a recirculating paint drying cabinet at 150° C. for 20 min. The reflectometer values were measured by BYK haze gloss after the glass panes had cooled down (at least 30 minutes). The reflectometer value was formed from the average of the duplicate determination.

FIG. 2 shows a grindometer image of K1 and K2

FIG. 3 shows a grindometer image of VG1 and VG2

TABLE 4
Evaluation of grindometer images

| | K1 | K2 | VG1 | VG2 |
|---|---|---|---|---|
| | [FIG. 2] | [FIG. 2] | [FIG. 3] | [FIG. 3] |
| Weight of silica in Black | 5.90 | 6.25 | 6.85 | 6.55 |
| Duplex D 1326 test paint [g] | | | | |
| (20 gloss units/60°) | | | | |
| D50 [um] | 4.3 | 4.0 | 3.8 | 4.3 |
| Grindometer value [μm] | 15 | 15 | 18 | 18 |
| Number of specks | 0 | 0 | 5 | 4 |
| Specks up to [μm] | — | — | 63 | 57 |

The grindometer images shown in FIGS. 2 and 3 for the inventive silicas K1 and K2 show a lower value by 3 μm than in the case of the comparative silicas VG1 and VG2. This is also associated with the lower d95% values from Table A, since the grindometer value is determined to a crucial degree by the coarser component of the grain collective. As in the case of the clearcoat systems 1, 2 and 3 shown above, the silicas according to the invention also showed higher efficiency in the black-pigmented Duplex D 1326 test paint since less matting agent had to be weighed in to establish a gloss level of 20, measured at a 60° angle. It is also noticeable that K1 and K2 in FIG. 2 have a much smaller transition range and no specks at all. In the case of many precipitated silicas with d50 values of less than 5 μm, the silica particles have a tendency to re-agglomerate during storage, which can be recognized by an increasing number of specks in the grindometer image over time. Usually, the tendency of untreated silicas to be agglomerated higher than in the case of those having organic coverage of the surface. This may already be the case after a few days in the case of silicas having a high tendency to reagglomerate, or only after weeks or months in the case of higher stability. In the case of the inventive silicas K1 and K2, by contrast, this was not observed, and hence confirms the very low tendency to speck formation. It is assumed that the specific morphology and pore distribution of silicas K1 and K2 not only has an advantageous effect on dispersibility, but also results in high stability to reagglomeration.

1. A precipitated silica, wherein
$$a BET is from 150 {m}^{2} / g - 400 {m}^{2} / g , determined to ISO 9277 ;$$
$$a DOA is from 220 ml / 100 g - ] 400 ml / 100 g , determined to ISO 19246 ;$$
$$a {d}_{50} is from 3. μm - 5. μm , \\ determined by laser diffraction on a Coulter LS to ISO 13320 ;$$
$$a particle size ratio {d}_{5} : {d}_{50} : {d}_{95} is > 0.3 : 1 \text{:<} 2 ; and$$
$$a particle size distribution \frac{{d}_{95} - {d}_{5}}{{d}_{50}} is between 1.3 and 1.7 .$$

2. The precipitated silica according to claim 1, wherein a median pore diameter is less than 7.0 μm, measured with an Autopore IV 9520 to ISO 15901-1, with the following instrument settings: contact angle of 140° and pressure range of 0.003-420 MPa, calculated in a pore diameter range of 3.5 nm-500 μm.

3. The precipitated silica according to claim 1, wherein a pore volume is greater than 2.40 ml/g (d=0.1 μm−d=4.0 μm)−3.10 ml/g (d=0.1 μm−d=4.0 μm), determined by means of the Hg porosimeter.

4. The precipitated silica according to claim 1, wherein a pore volume is greater than 2.50 ml/g (d=0.1 μm−d=5.0 μm)−3.30 ml/g (d=0.1 μm−d=5.0 μm), determined by means of the Hg porosimeter.

5. The precipitated silica according to claim 1, wherein the d₅₀ is 3.5-4.5 μm.

6. A composition, comprising:
a matting agent comprising the precipitated silica according to claim 1, wherein the composition is selected from the group consisting of dispersions, millbases, paints, coatings or printing inks, inkjet inks, grind resins, pigment concentrates, colour preparations, pigment preparations, filler preparations and coating compositions.

7. A wax-coated precipitated silica, wherein
$$a BET is from 150 {m}^{2} / g - 400 {m}^{2} / g , measured to ISO 9277 ;$$
$$a DOA is from 220 ml / 100 g - 400 ml / 100 g , determined to ISO 19246 ;$$
$$a {d}_{50} is from 3. μm - 5. μm , \\ measured by laser diffraction ( Coulter LS ) to ISO 13320 ;$$
$$a particle size ratio {d}_{5} : {d}_{50} : {d}_{95} is > 0.3 : 1 \text{:<} 2 ;$$
$$a particle size distribution \frac{{d}_{95} - {d}_{5}}{{d}_{50}} is between 1.3 and 1.7 ; and$$
$$a carbon content is 1 \text{.0} - 6. \% by weight , \\ measured by LECO to ISO 3262 - 19.$$

8. A composition, comprising:
a matting agent comprising the wax-coated precipitated silica according to claim 7, wherein the composition is selected from the group consisting of dispersions, millbases, paints, coatings or printing inks, inkjet inks, grind resins, pigment concentrates, colour preparations, pigment preparations, filler preparations and coating compositions.

9. The precipitated silica according to claim 1, wherein the BET is from 200 m²/g-300 m²/g.

10. The precipitated silica according to claim 1, wherein the DOA is from 250 ml/100 g-350 ml/100 g.

11. The precipitated silica according to claim 2, wherein the median pore diameter is less than 5.0 μm.

12. The precipitated silica according to claim 2, wherein the median pore diameter is less than 3.0 μm.

13. The wax-coated precipitated silica according to claim 7, wherein the BET is from 200 m²/g-300 m²/g.

14. The wax-coated precipitated silica according to claim 7, wherein the DOA is from 250 ml/100 g-350 ml/100 g.

15. The wax-coated precipitated silica according to claim 7, wherein the carbon content is 2.4-3.8% by weight.
